(19) United States
(12) Patent Application Publication
(10) Pub. No.: US 2009/0270033 A1
(43) Pub. Date: Oct. 29, 2009

(54) Public Information Method and System

(75) Inventors: Jacques Le Gars, Gambais (FR); Jacques Darras, Rambouillet (FR)

Correspondence Address: MILLER, MATTHIAS & HULL, ONE NORTH FRANKLIN STREET, SUITE 2350, CHICAGO, IL, 60606, US

(73) Assignee: JCDecaux SA, Neuilly Sur Seine (FR)

(21) Appl. No.: 12/300,997

(22) PCT Filed: May 15, 2007
(86) PCT No.: PCT/FR07/51276

§ 371 Date: Nov. 14, 2008

(30) Foreign Application Priority Data
May 17, 2006 (FR) 0604423

(51) Int. Cl. H04B 7/00

(52) U.S. Cl. 455/41.2

(57) ABSTRACT

Public information system, wherein information bases communicate information interactively to mobiles via a short-range radio link. Each mobile has interface software enabling the information base to display the information on the screen of the mobile as if the screen were a device of the information base, and enabling the user to communicate data to the information base via the keypad of said mobile as if the mobile input interface were a device of the information base.

The present invention relates to public information methods and systems.

More particularly, the invention relates to a method of public information in which an information base, including an electronic central processing unit, communicates information interactively to users.

Methods of this type are known in which the information base is an interactive terminal located in a public place and equipped with a screen and keyboard.

Such interactive terminals have several drawbacks:

the presentation of the information on the screen lacks privacy,

they can give information only to a single user at a time,

they are vulnerable to vandalism.

The present invention has the purpose in particular of remedying these drawbacks.

To this end, according to the invention, a method of the type in question is characterized in that it uses several types of mobiles carried by users and capable of establishing a short-range two-way radio link with the information base using a predetermined radio communication protocol, each mobile including an electronic central processing unit connected to a screen and to an input interface allowing the user to communicate data to the mobile, and in that it comprises the following steps:

(a) a step of establishing a radio link, during which, when one of said mobiles arrives in the vicinity of the information base, a two-way radio communication is established between the information base and the mobile, using said radio communication protocol,

(b) a step of interactive communication, during which:

the central processing unit of the information base displays the information on the screen of the mobile by means of interface software loaded on the central processing unit of the mobile, the central processing unit of the information base sending said information in a format which is independent of the type of mobile as if the screen of the mobile were a peripheral of the information base, and said information for display being converted by the interface software to a format compatible for the control of the screen of the mobile,

and the user communicates data (commands in particular) to the information base by means of the input interface of said mobile, said data being converted by the interface software to a format compatible with the central processing unit of the information base and then transferred to said information base independently of the type of the mobile, as if the input interface of the mobile were a peripheral of the information base.

By means of these arrangements, the user receives the requested information in complete privacy on his mobile, the base can optionally give information to several users at once, and optionally, it is no longer necessary for the information base to include a screen and keyboard, which makes it less vulnerable to vandalism (furthermore, the information base can be completely hidden in a building or street furniture, and be indicated only by a notice or similar).

In various embodiments of the method according to the invention, it is moreover optionally possible to use one and/or another of the following arrangements:

the radio communication protocol is chosen from the Bluetooth, ZigBee and Wi-Fi protocols;

the information base comprises a local database, and this local database is supplied at time intervals from a general database belonging to a central server.

A further subject of the invention is also a public information system including at least one information base capable of communicating information interactively to users, said information base including an electronic central processing unit,

characterized in that it further includes several types of mobiles, each including an electronic central processing unit linked to a screen and to an input interface allowing the user to communicate data on the mobile, the information base and each mobile being capable of automatically establishing between themselves a short-range two-way radio link using a predetermined radio communication protocol when said mobile arrives in the vicinity of the information base,
and in that the central processing unit of the mobile includes a software interface capable of:

converting display instructions originating from the central processing unit of the information base to a format compatible with control of the screen of the mobile, in such a way that the central processing unit of the information base sends said information in a format independent of the type of mobile, as if the screen of the mobile were a peripheral of said central processing unit of the information base,

and converting data (commands in particular) received from the input interface of the mobile to a format compatible with the central processing unit of the base and transferring said data to the information base, as if the input interface of the mobile were a peripheral of said central processing unit of the information base.

In various embodiments of the system according to the invention, it is moreover optionally possible to use one and/or another of the following arrangements:

the radio communication protocol is chosen from the Bluetooth, ZigBee and Wi-Fi protocols;

the system includes several information bases each comprising a local database, the information bases communicating with a central server and being capable of interrogating, in order to supply the local database at time intervals, from a general database belonging to the central server;

the input interface of the mobile comprises a keyboard;

the information base has no keyboard or screen.

Other characteristics and advantages of the invention will become apparent from the following description of one of its embodiments, given by way of non-limiting example in relation to the attached drawings.

In the drawings:

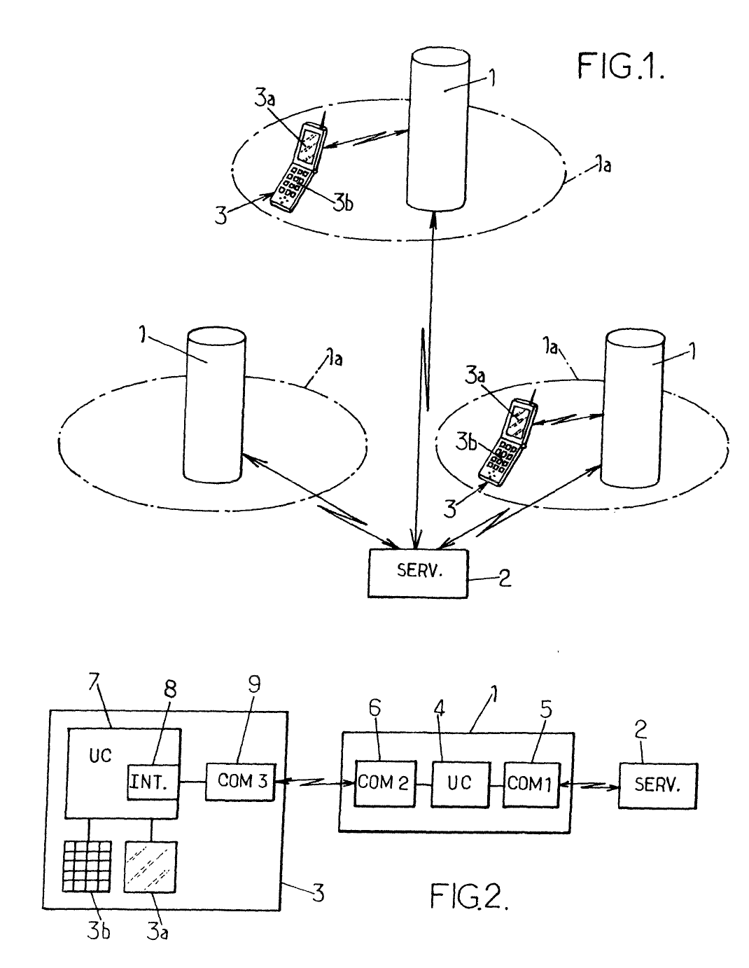

FIG. 1 is a diagrammatic view of an information system according to an embodiment of the invention, and

FIG. 2 is a block diagram showing part of the information system of FIG. 1.

In the different figures, the same references denote identical or similar elements.

FIG. 1 represents a public information system which includes at least one information base 1 (in practice, a plurality of information bases 1) capable of communicating for example with a central server 2 (SERV.) by any known means, for example by wired or wireless link. Each information base 1 is moreover capable of communicating locally with mobiles 3 by a short-range radio link, using a predetermined two-way radio communications protocol, for example the Bluetooth protocol (IEEE standard 815.15.1) or the ZigBee protocol (IEEE standard 802.15.4), or also the Wi-Fi protocol (IEEE standard 802.11).

The range of the radio link between the information bases 1 and the mobile 3 can be for example of the order of a few tens of metres and generally less than 200 m. The geographical zones covered by the short range radio link around each information base 1 are represented in FIG. 1 by boundaries la shown in chain dotted lines.

The information bases 1 can for example be in the form of terminals 1 without keyboard or screen (therefore substantially unaffected by vandalism). Said information bases 1 can even be invisible to the public and integrated into a building or street furniture. In the latter case, the approximate locations of the information bases 1 can be indicated to the public by notices or other things, so that users of the mobiles 3 know in what area they must be positioned in order to be able to receive information, as will be explained below.

As regards the mobiles 3, they can be for example cell phones equipped with a short-range radio link operating according to the above-mentioned radio communication protocol, or also personal digital assistants, or any other electronic device having such radio link interfaces. Each mobile 3 is equipped with a screen 3a and an input interface such as a keyboard 3b or other.

As shown in FIG. 2, the information base 1 can include for example an electronic central processing unit 4 (UC) such as a microprocessor, microcontroller or other, which is linked to a first communication interface 5 (COM 1) capable of communicating with the server 2 and to a second communication interface 6 (COM 2) capable of communicating with the mobiles 3 using the above-mentioned radio communication protocol.

As regards each mobile 3, it also includes an electronic central processing unit 7 (UC) such as a microprocessor, microcontroller or other, which is linked to a communication interface 9 (COM 3) capable of communicating with the information bases 1 using the above-mentioned radio communication protocol.

Furthermore, interface software 8 (INT.) is loaded in the central processing unit 7 of each mobile 3, capable of standardizing the communication between the information bases 1 and the mobiles 3, independently of the type of the mobile 3. This software can for example be programmed under Java if allowed by the mobile 3, or if not under a specific operating system of the mobile 3.

More specifically, the interface software 8 is capable of:

converting the display instructions originating from the information base 1 to a format compatible with control of the screen 3a of the mobile, so that the information base 1 can make the information be displayed on the screen 3a of the mobile independently of the type of mobile, as if the screen of the mobile were a peripheral of the base,

and converting data, i.e. in practice essentially commands, received from the keyboard 3b of the mobile into a format compatible with the base 1, and transferring this data to the base so that said data can be received by the base as if the keyboard 3b of the mobile were a peripheral of the base, and independently of the type of the mobile 3.

As a result, the interface software 8 is different according to the types of mobiles 3 and allows a standardized communication of each information base 1 with the mobiles 3.

In the embodiment envisaged here, each information base 1 has a local database in memory, which is loaded with relevant information with regard to the location of the information base 1. In order to keep this local database updated, each information base 1 interrogates the central server 2, which contains a general database, at regular time intervals, taking from it information corresponding to certain predefined criteria associated with the information base 1 in question.

By way of example, each record (“event”) from the general database can for example be allocated to the following indexes:

geographical coordinates,

general subject,

particular subject,

specific subject.

Each information base is moreover characterized by its own geographical coordinates.

Thus when the information base 1 interrogates the server 2, the latter transmits geographically relevant information to it, i.e. database records, the geographical coordinates of which are located for example at a distance less than a predetermined limit from the information base 1 concerned.

The information obtained from the general database in this way is transmitted to the local database of the information base 1 concerned, and grouped for example by general, particular and specific subject-matter (each particular subject is a subdivision of a general subject and each specific subject is a subdivision of a particular subject), which then determines the hierarchy structure for access to the information in the information base 1.

The general, particular and specific subject-matters in question can be pre-defined.

For example, the general subjects can be leisure and transport. The particular subjects within the subject “leisure” can comprise for example museums and cinemas. The specific subjects within the particular subject “museum” can comprise for example painting and sculpture. The specific subjects within the particular subject “cinema” can comprise for example comedy, detective films, etc. Similarly, for the general subject “transport”, the particular subjects can comprise for example buses and the underground, and the specific subjects within each of these particular subjects can comprise routes and stops.

The information system which has just been described operates as follows: When a user equipped with his mobile 3 comes within the range 1a of an information base 1, the radio link is automatically established between the information base 1 and the mobile 3, the radio communication protocol being capable of establishing ad-hoc networks.

The information base can then send pages for display to the mobile 3, using the interface software 8 (optionally after acceptance of the dialogue by the user, or after a request for dialogue by the user and, if applicable, on condition that the user has taken out a subscription).

These pages for display include for example images and/or text and scrolling menus. These pages are displayed on the screen 3a of the mobile, and the user of the mobile 3 can move a cursor in the scrolling menu, by means for example of directional keys on the keyboard 3b.

When the user validates a choice of the scrolling menu by means of a predefined validation key of the keyboard 3b, this validation is transmitted to the information base 1 using the interface software 8, after which the information base 1 sends a new page for display or if appropriate finishes the interactive dialogue with the mobile 3, according to the choice made by the user in the scrolling menu.

The user can thus receive general, tourist or practical information (timetables or waiting times for public transport, availability of free public bicycles, etc.), or others.

This information is provided to the user in privacy. Furthermore, the information base 1 can dialogue simultaneously with several mobiles 3 and thus give information simultaneously to several users.

1. A public information method, in which an information base, including an electronic central processing unit, communicates information interactively to users,
wherein it uses mobiles of several types carried by users and equipped to establish with the information base a short-range two-way radio link using a predetermined radio communication protocol, each mobile including an electronic central processing unit linked to a screen and to an input interface allowing the user to communicate data to the mobile, and
wherein it comprises the following steps:
a step of establishing a radio link, during which, when one of said mobiles arrives in the vicinity of the information base, a two-way radio communication is established between the information base and the mobile using said radio link communication protocol,
a step of interactive communication, during which:
the central processing unit of the information base makes the information be displayed on the screen of the mobile by means of interface software loaded on the central processing unit of the mobile, the central processing unit of the information base sending said information in a format which is independent of the type of mobile, and said information to be displayed being converted by the interface software to a format compatible with control of the screen of the mobile,
and the user communicates data to the information base by means of the input interface of said mobile, said data being converted by the interface software to a format compatible with the central processing unit of the information base and then transferred to said information base independently of the type of mobile.

2. The public information method according to claim 1, in which the radio communication protocol is chosen from the Bluetooth, ZigBee and Wi-Fi protocols.

3. The public information method according to claim 1, in which the information base comprises a local database, and this local database is supplied at time intervals from a general database belonging to a central server.

4. The public information system including at least one information base capable of communicating information interactively to users, said information base including an electronic central processing unit, wherein it further includes mobiles of several types, each including an electronic central processing unit linked to a screen and to an input interface allowing the user to communicate data on the mobile, the information base and each mobile being capable of automatically establishing between them a short-range two-way radio link using a predetermined radio communication protocol, when said mobile arrives in the vicinity of the information base, and
wherein the central processing unit of the mobile includes interface software capable of:
converting display instructions originating from the central processing unit of the information base to a format compatible with control of the screen of the mobile, so that the central processing unit of the information base sends said information in a format independent of the type of mobile,
converting data received from the input interface of the mobile to a format compatible with the central processing unit of the base and transferring said data to the information base.

5. The public information system according to claim 4, in which the radio communication protocol is chosen from the Bluetooth, ZigBee and Wi-Fi protocols.

6. The public information system according to claim 4, including several information bases each comprising a local database, the information bases communicating with a central server and being capable of interrogating, in order to supply the local database at time intervals, from a general database belonging to the central server.

7. The system according to claim 4, in which the input interface of the mobile comprises a keyboard.

8. The system according to claim 4, in which the information base has no keyboard or screen.
